(19) United States
(12) Patent Application Publication
(10) Pub. No.: US 2025/0268697 A1
(43) Pub. Date: Aug. 28, 2025

(54) REMOVABLE TOOTHBRUSH HEAD FOR ELECTRIC TOOTHBRUSH HANDLE

(71) Applicant: Oralic Supplies, Inc., Diamond Bar, CA (US)

(72) Inventor: Jun Lee, Irvine, CA (US)

(21) Appl. No.: 18/590,678

(22) Filed: Feb. 28, 2024

(51) Int. Cl. A61C 17/22; A46B 5/00; A46B 9/04; A46B 13/02; A61C 17/34

(52) U.S. Cl. CPC A61C 17/222; A46B 5/002; A46B 5/0095; A46B 9/04; A46B 13/023; A61C 17/3481

(57) ABSTRACT

A toothbrush head includes a bristle tray, a base having an opening for receiving an electric toothbrush a drive shaft, a stem that connects the bristle tray to the base, and a coupling member, The coupling member does not require a spring to contact the drive shaft or stem. In some embodiments, the coupling member includes an interior sidewall that surrounds a chamber for receiving the drive shaft and a receptacle positioned to align with an opening of the stem, and a pin is positioned within the opening and the receptacle. In other embodiments, the coupling member includes a relatively narrower section positioned to align with the stem and a relatively wider section positioned to align with the base, and when the drive shaft is inserted into the coupling member, the drive shaft will extend from the relatively narrower section and into an interior cavity within the stem.

### BACKGROUND

This disclosure relates to the field of electric toothbrushes, and particularly brush heads that are configured to couple to an electric toothbrush handle.

Many types of electric toothbrushes use high speed vibrations of the motor inside the toothbrush handle to drive the brush head. In order to operate the electric toothbrush, the construction of the brush head requires that it be tightly coupled to the drive shaft of the toothbrush handle so it can withstand the high speed vibrations from operating the toothbrush. Therefore, many existing products use metal or springs inside the brush head to facilitate a tight coupling to the drive shaft of the toothbrush handle. This can increase the cost of making the brush head.

In addition, while some brush heads avoid the use of metal springs, those brush heads can sometimes have difficulty staying connected to the handle, and/or they may not offer as much vibratory effect due to a loose fit.

This patent document describes an apparatus that addresses at least some of the issues described above and/or other issues.

### SUMMARY

In a first aspect, a toothbrush head for an electric toothbrush includes a bristle tray having a plurality of bristles, a base having an opening for receiving a drive shaft of the electric toothbrush, a stem that connects the bristle tray to the base and that has an opening, and a coupling member. The coupling member includes an interior sidewall that surrounds a chamber for receiving the drive shaft, as well as a receptacle positioned to align with the opening of the stem. The coupling member does not include or rely on a spring to contact the drive shaft or the stem. A pin is positioned within the opening of the stem and the receptacle of the coupling member.

In a second aspect, a toothbrush head for an electric toothbrush includes: (a) a bristle tray that includes a plurality of bristles; (b) a base having an opening for receiving a drive shaft of an electric toothbrush; (c) a stem that connects the bristle tray to the base and that has an opening; and (d) a coupling member. The coupling member includes (a) a relatively narrower section positioned to align with the stem and (b) a relatively wider section positioned to align with the base. The relatively narrower section has a length that is shorter than that of the drive shaft so that, when the drive shaft is inserted into the coupling member, the drive shaft will extend from the relatively narrower section and into an interior cavity within the stem.

In a third aspect, a toothbrush comprises a handle with a drive shaft extending therefrom, and a toothbrush head. The toothbrush head includes a bristle tray comprising plurality of bristles, a base having an opening for receiving the drive shaft, a stem that connects the bristle tray to the base and that has an opening, and a coupling member. The coupling member includes a relatively narrower section positioned to align with the stem and a relatively wider section positioned to align with the base. The relatively narrower section has a length that is shorter than that of the drive shaft so that, when the drive shaft is inserted into the coupling member, the drive shaft will extend from the relatively narrower section and into an interior cavity within the stem. The interior sidewall of the stem comprises an irregular surface that is positioned to contact the drive shaft when inserted into the toothbrush head. The drive shaft also comprises an irregular surface that is positioned to contact the interior sidewall of the stem when the drive shaft is inserted into the toothbrush head.

### BRIEF DESCRIPTION OF THE DRAWINGS

FIG. 1 is a perspective view of an electric toothbrush handle and removable toothbrush head.

FIGS. 2 and 3 illustrate a first embodiment of a toothbrush head with a coupling member according to the present disclosure.

FIG. 4 illustrates a variation of the embodiment of FIGS. 2 and 3.

FIG. 5 illustrates a second embodiment of a toothbrush head with a coupling member according to the present disclosure.

FIG. 6 illustrates a first variation of the embodiment of FIG. 5.

FIGS. 7A and 7B illustrate a second variation of the embodiment of FIG. 5.

FIGS. 8A and 8B illustrate a third variation of the embodiment of FIG. 5.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun, such use is simply intended to distinguish one item from another, and the terms not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

In this document, the term “connected”, when referring to two physical structures, means that the two physical structures touch each other. Devices that are connected may be secured to each other, or they may simply touch each other and not be secured.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

This disclosure is not limited to the particular systems, methodologies or protocols described, as these may vary. The terminology used in this description is for the purpose of describing the particular versions or embodiments only, and it is not intended to limit the scope.

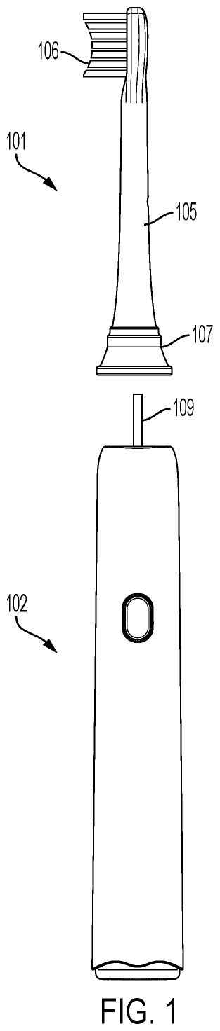

In various embodiments, a brush head 101 is couplable to a drive shaft 109 of an electric toothbrush handle 102, as shown in FIG. 1. The brush head 101 includes a bristle tray 106 that is a substrate from which multiple attached bristles extend. The brush head 101 also has a stem 105, which extends from the bristle tray 106, leading to a base 107 that flares outward from the stem. In use, the base will be placed over and attach to the drive shaft 109 of the electric toothbrush handle 102. The handle 102 includes a motor and/or other electrical components that, when actuated, will cause the drive shaft 109 to vibrate. When the brush head 101 is attached to the drive shaft 109, the vibration is transferred along the stem 105 to the bristle tray 106, to facilitate brushing of the user's teeth.

The stem 105 and base 107 each have an opening, along with one or more internal structures, that are configured to receive and attach to the drive shaft 109. The internal structures may be integral with the stem 105 and/or base 107, such as part of a sidewall of an interior cavity of the stem 105 and/or base 107. Alternatively or in addition, some or all of the internal structures may be formed in a coupling member that fits within the interior cavity. Examples of such structures will be described below.

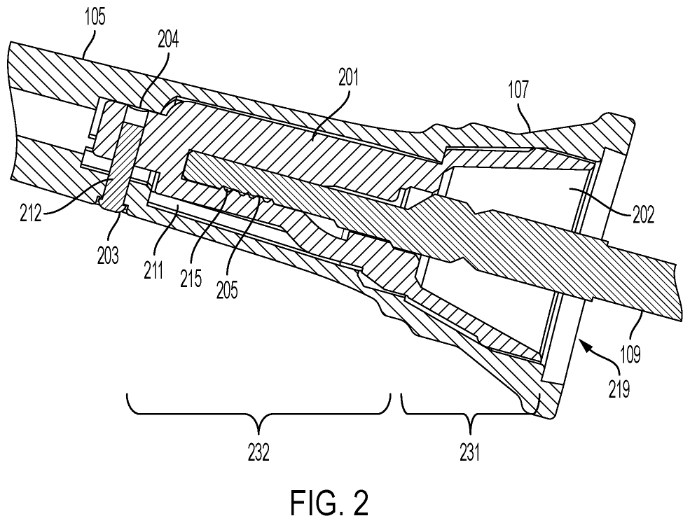

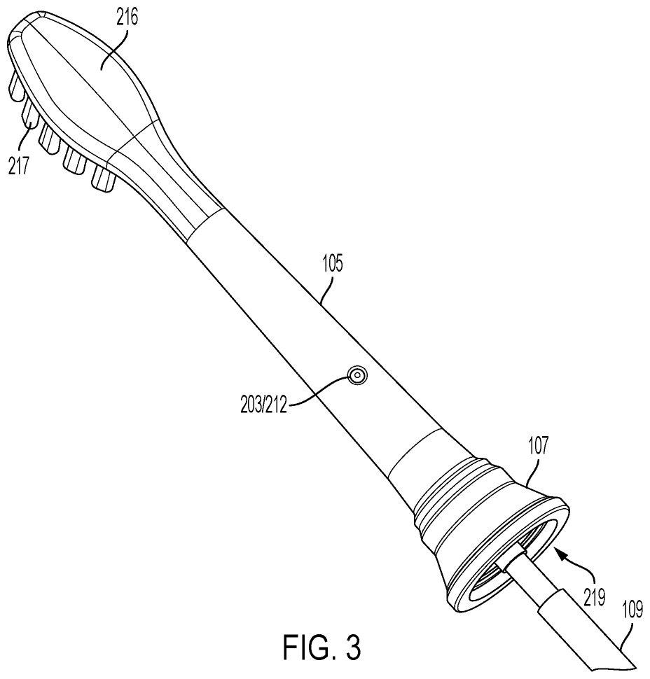

One configuration is shown in FIGS. 2 and 3. FIG. 2 is a cross-sectional view, while FIG. 3 is an exterior view. In this embodiment, a coupling member 201 fits within the interior cavity 211 of the stem 105 and base 107. The coupling member 201 includes a chamber 202 that includes a relatively wider section 231 that is positioned to align with the base 107 and a relatively narrower section 232 that is positioned to align with the stem 105. Optionally, the interior sidewall of the relatively narrower section 232 may be cylindrical. Optionally, the interior sidewall of the relatively wider section 231 may be funnel-shaped with an opening aligned with the opening 219 and a sidewall having a taper that narrows as it gets closer to the interior sidewall of the relatively narrower section 232

When the drive shaft 109 is placed through the opening 219 of the brush head, it will be received into the chamber 202 and connect to a sidewall of the relatively narrower section 232 of the chamber 202. Optionally, as shown the drive shaft may not contact any portion of the sidewall of the relatively wider section 231 of the chamber 202.

The connection of the drive shaft 109 to the sidewall of the relatively narrower section 232 may be at least in part a friction fit. In some embodiments, the drive shaft 109 may include an irregular (i.e., textured and not smooth) surface 205 such as teeth, a gear, or a ledge that promotes a fit with the sidewall of chamber 202. In some embodiments, the interior sidewall of the relatively narrower section 232 of the chamber 202 may include an irregular surface 215 such as a tooth or multipole teeth, a gear, or a ledge that promotes contact with the drive shaft 109. In some embodiments, both the interior sidewall of the relatively narrower section 232 of the chamber 202 and the drive shaft 109 may have irregular surfaces 215, 205 that are positioned to align with each other. For example, each irregular surface 215, 205 may include a gear in which the teeth of one irregular surface (such as surface 215) are positioned to align with gaps between teeth of the other irregular surface (such as surface 205). With such a connection, the coupling member does not include or rely on a spring to contact the drive shaft or the stem to transfer vibration from the drive shaft or provide support to the brush head on the drive shaft.

The height of the irregular surface of either element may be sufficient to provide a friction fit between the drive shaft and the interior sidewall of the relatively narrower section 232, while still being separable with a moderate pulling force by a human. In this way, the brush head is removably attached to the drive shaft of the handle.

An end of the portion of the coupling member 201 that includes the relatively narrower section 232 may include a receptacle 204 that is positioned to align with an opening 203 of the stem 105. The receptacle 204 may have a longitudinal axis that is substantially perpendicular to the longitudinal axis of the stem 107. A pin 212 may be positioned within the opening 203 and the receptacle 204 to provide further stability and hold the coupling member in place. The pin may be made of metal such as aluminum, or it may be made of a rigid or semi-rigid plastic material.

FIG. 3 also shows the substrate 216 and bristles 217 of the bristle tray 106.

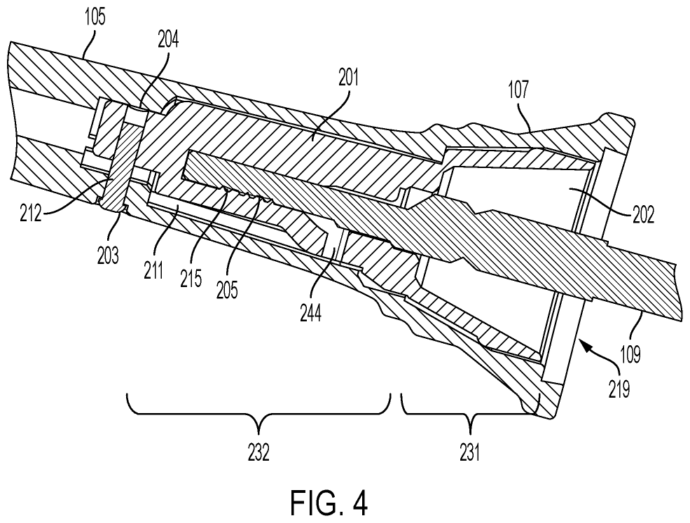

In the embodiment of FIG. 2, the interior sidewall of the relatively narrower section 232 that surrounds the chamber 202 fully surrounds the chamber 202 without a break in the interior sidewall. FIG. 4 shows an alternate embodiment in which the interior sidewall includes a break 244 (i.e., an opening) so that part of the chamber 202 is open and faces the stem. Optionally, the break 244 may be positioned in other locations on the interior sidewall, and in some embodiments the interior sidewall may have multiple breaks.

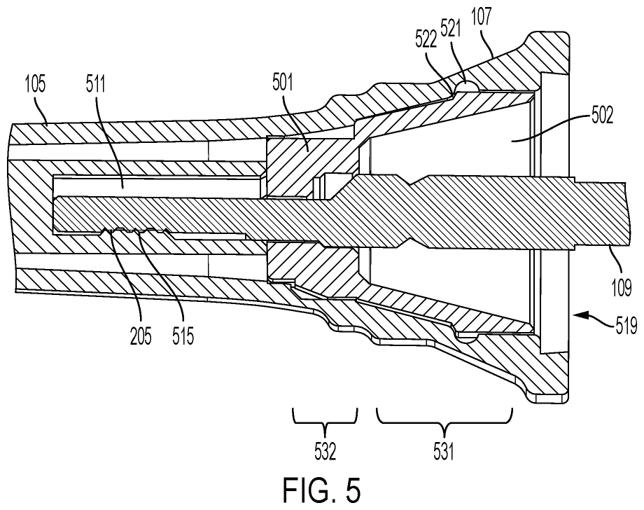

FIG. 5 is a cross-sectional view of a second embodiment in which the coupling member 501 also fits within the interior cavity 511 of the stem 105 and base 107. The coupling member 501 includes a chamber 502 that includes a relatively wider section 531 that is positioned to align with the base 107 and a relatively narrower section 532 that is positioned to align with the stem 105. However, unlike the embodiment of FIGS. 2 and 3, the relatively narrower section 532 of the embodiment of FIG. 5 has a length that is shorter than that of the drive shaft 109, and no pin secures the coupling member 501 in place. The drive shaft 109 therefore extends out from a top end of the relatively narrower section 532 and into the interior cavity 512 of the stem 105.

The interior cavity 511 of the stem 105 may be cylindrical. When the drive shaft 109 is placed through the opening 519 of the brush head, it will be received into the interior cavity 511 of the stem 105 and connect to a sidewall of the interior cavity 511 of the stem 105. Optionally, as shown the drive shaft may not contact any portion of the sidewall of the relatively wider section 531 of the chamber 502.

The connection of the drive shaft 109 to the interior cavity 511 of the stem 105 may be at least in part a friction fit. In some embodiments, the drive shaft 109 may include an irregular (i.e., textured and not smooth) surface 205 such as teeth, a gear, or a ledge that promotes a fit with the sidewall of interior cavity 511. In some embodiments, the interior cavity 511 may include an irregular surface 515 such as a tooth or multiple teeth, a gear, or a ledge extends from the sidewall of the interior cavity 511 and promotes contact with the drive shaft 109. In some embodiments, both the interior sidewall of the relatively narrower section 532 of the chamber 551 and the drive shaft 109 may have irregular surfaces 515, 205 that are positioned to align with each other. For example, each irregular surface 515, 205 may include a gear in which the teeth of one irregular surface (such as surface 515) are positioned to align with gaps between teeth of the other irregular surface (such as surface 205).

The height of the irregular surface of either element may be sufficient to provide a friction fit between the drive shaft and the interior sidewall of the relatively narrower section 532, while still being separable with a moderate pull by a human. In this way, the brush head is removably attached to the drive shaft of the handle.

In this embodiment, the interior sidewall of the relatively wider section 531 may include a cylindrical first subsection near the opening 519, followed by a funnel-shaped second subsection having a taper that narrows as it gets closer to the interior sidewall of the relatively narrower section 232. The transition from the cylindrical first section to the tapered second subsection may occur at a corner 522, which may include a ledge or ridge that is positioned to align with a corresponding corner 521, which may be a ledge or ridge of the interior sidewall of the base 107 of the stem. The corner 521 of the interior sidewall of the base 107 of the stem thus serves as a stop to limit a path of travel of the coupling member into the interior cavity 511 of the stem 105.

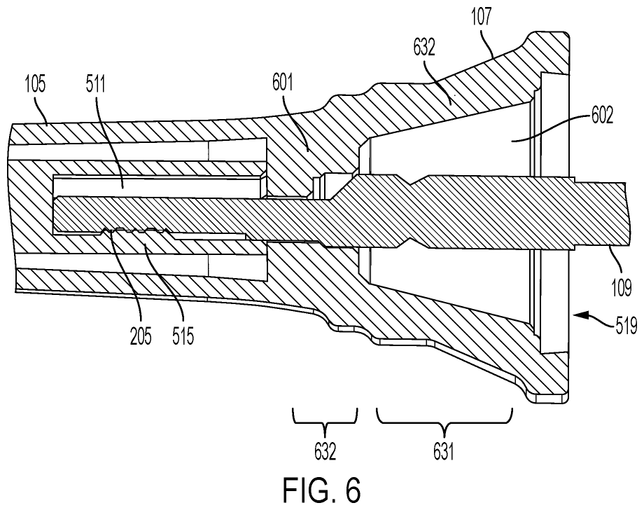

FIG. 6 illustrates a variation of FIG. 5 in which the coupling member 601 is integral with the stem 105 and base 107 and thus not a separate part. In FIG. 6, coupling member 601 narrows the portion of the interior cavity 511 that is positioned between the stem 105 and base 107. The portion of the base 107 that includes the coupling member 601 includes a chamber 602 with includes a relatively wider section 631 that is positioned to align with the base 107, and the portion of the stem 105 that includes the coupling member 601 includes a relatively narrower section 632 that is positioned to align with the stem 105. All other elements of the embodiment of FIG. 6 are the same as those discussed above for FIG. 5.

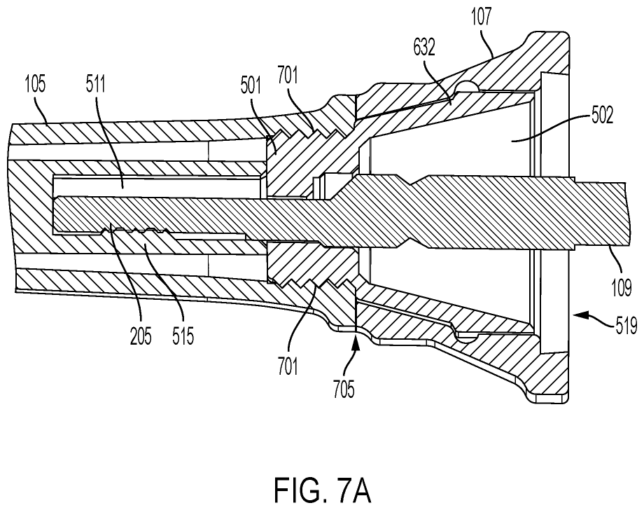

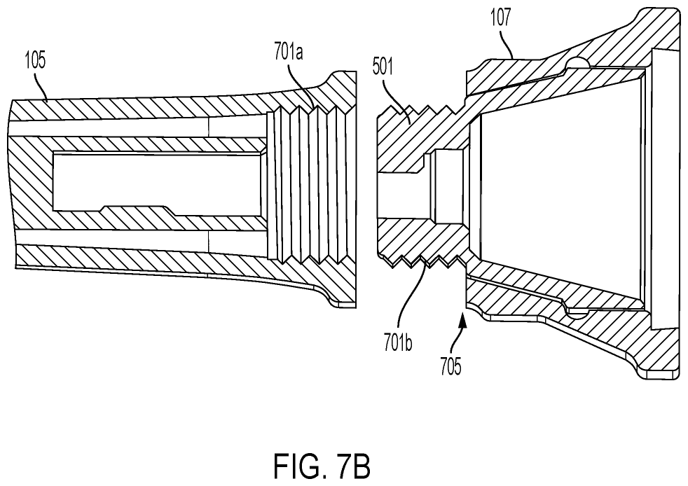

FIGS. 7A and 7B illustrate a different variation of the embodiment of FIG. 5 in which the upper (relatively narrower) portion of coupling member 501 is coupled to the relatively narrower portion of interior of stem 105 by a set of threads 701. FIG. 7A shows coupling member 501 attached to stem 105 by threads 701, which forms a seam 705 between stem 105 and base 107. FIG. 7b shows stem 105 and base 107 separated from each other, and that the interior sidewall of stem 105 includes threads 701a that are sized and arranged to mate with threads 701b that are positioned on the exterior sidewall of the upper portion of coupling member 501.

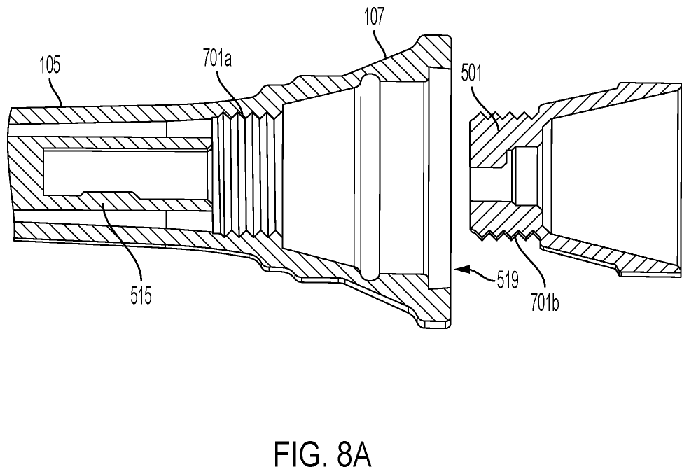

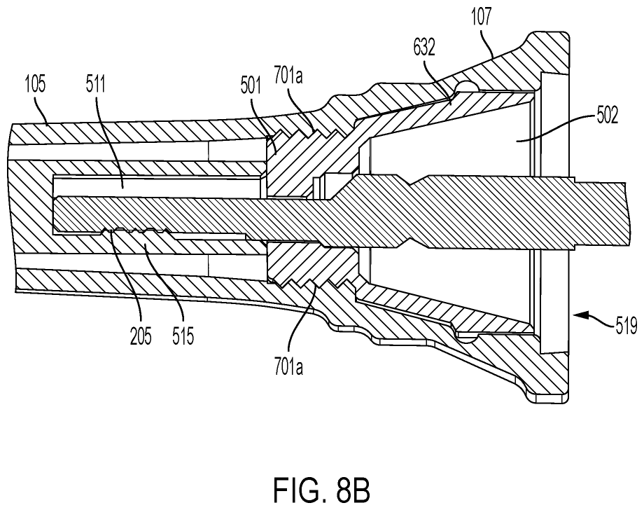

FIGS. 8A and 8B illustrate a different variation of the embodiment of FIG. 5 in which, like embodiment of FIGS. 7A and 7B, the upper (relatively narrower) portion of coupling member 501 is coupled to the relatively narrower portion of interior of stem 105 by a set of threads 701. However, in this embodiment stem 105 and base 107 do not separate from each other. Instead, as shown in FIG. 8A, before assembly coupling member 501 begins outside of interior cavity 511. In FIG. 8B, coupling member 501 is placed in cavity 511 and turned so that the threads 701b on the exterior of the coupling member mate with threads 701a that are positioned on the interior sidewall of the stem 105.

Optionally, in the embodiments of FIGS. 7A-7B and 8A-8B, instead of positioning the threads on an interior sidewall of the stem, the threads could be positioned on an interior sidewall of the base. If so, then the threads on the coupling member may be positioned further down the sidewall than the figures here depict, so that the coupling member's threads are on the relatively wider portion of the coupling member. If this variation is used in the embodiment of FIGS. 7A and 7B, then the seam would not be positioned between the stem and the base but instead would be positioned somewhere on the base.

Notably, in each of the embodiments described above, no metal spring is used to transfer vibration from the drive shaft to the bristle tray. The embodiments described above eliminate the need for a metal spring. However, a spring may optionally be included in any of the embodiments.

In the various embodiments above, the coupling member and/or stem may be made of a resilient material, to provide a spring function that allows the drive shaft to vibrate when the coupling member or stem is positioned against the drive shaft. For example, at least the interior sidewall of the coupling member and/or stem may be formed of a soft plastic such as a low density polyethylene (LDPE), rubber, or other soft yet strong material. The entire coupling member or stem may be made of such material, or the gear or the interior sidewall of the stem or coupling member may be made of such materials.

Various aspects of the configurations described above may be combined with each other. For example. Other combinations are possible.

The disclosures of the following United States Patents and Patent Applications are incorporated into this document by reference: U.S. Pat. Nos. 9,724,180; 9,827,079; 11,890,153; US 2022/0273407; and US 2023/0338126.

In various embodiments, the exterior sidewalls of the coupling member may be smooth as shown in FIGS. 2-4. Alternatively, the exterior sidewalls of the coupling member may include ridges that are positioned to align with receptacles of the interior sidewall of the stem, or receptacles that are positioned to align with ridges of the interior sidewall of the stem, such as is disclosed in the patents incorporated by reference above.

The various embodiments disclosed in this patent document provide advantages over the prior art, whether standalone or combined. For example, the resilient wall of the handle coupling section of the coupling member that is positioned to engage with the drive shaft of the electric toothbrush handle may be made from the same wall of the handle coupling section of the coupling member, which requires no metal spring or other separate resilient member. This both achieves a tight coupling (because there is no separate part) and reduces the cost of making. Further, multiple engagements of various parts of the stem and the coupling member all facilitate a tight coupling between the coupling member and the stem, and thus improve the stability of the brush head as it is operating under the high speed vibrations of the motor inside the handle.

Further, the toothbrush head may be easy to manufacture as all the parts can be made of plastic or polyester materials. The cone shaped opening of the stem may facilitate easy receiving and coupling of the coupling member into the stem, and multiple engagement means, such as, the longitudinal ridge of the coupling member and the corresponding longitudinal channel in the stem, the mounting channel of the coupling member and the corresponding ridge block in the stem, the raised resilient wall of the coupling member and the corresponding coupling channel in the stem, the mounting block of the coupling member and the corresponding mounting channel in the stem, the base ring of the coupling member and the mating sitting platform in the stem, the mounting holes of the coupling member and the mounting ridges in the stem, each may facilitate easy sliding and positioning of the coupling member into the stem and secure mounting of the coupling member to the stem.

Other advantages of the present invention can be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described in this document, but is intended to include all changes and modifications that are within the scope and spirit of the invention as defined in the claims.

Various aspects of the invention are also described in the following clauses. The features of these clauses may be variously combined with features of others of these clauses, as well as with other features described above in this document.
Clause 1: A toothbrush head for an electric toothbrush includes a bristle tray having a plurality of bristles, a base having an opening for receiving a drive shaft of the electric toothbrush, a stem that connects the bristle tray to the base and that has an opening, and a coupling member. The coupling member includes an interior sidewall that surrounds a chamber for receiving the drive shaft, as well as a receptacle positioned to align with the opening of the stem. The coupling member does not include or rely on a spring to contact the drive shaft or the stem. A pin is positioned within the opening of the stem and the receptacle of the coupling member.
Clause 2: The toothbrush head of clause 1, wherein the coupling member comprises (a) a relatively narrower section positioned to align with the stem, and (b) a relatively wider section positioned to align with the base.
Clause 3: The toothbrush head of clause 2, wherein an interior sidewall of the relatively narrower section comprises an irregular surface that is positioned to contact the drive shaft when inserted into the toothbrush head.
Clause 4: The toothbrush head of clause 2 or 3, further comprising the electric toothbrush, and wherein the drive shaft comprises an irregular surface that is positioned to contact an interior sidewall of the relatively narrower section when the drive shaft is inserted into the toothbrush head.
Clause 5: The toothbrush head of any of clauses 2-4, further comprising the electric toothbrush, and wherein: (a) the drive shaft comprises a first gear that is positioned to contact an interior sidewall of the relatively narrower section when the drive shaft is inserted into the toothbrush head; (b) the interior sidewall of the relatively narrower section comprises a second gear comprising teeth that extend toward the drive shaft; and (c) the teeth of the second gear are positioned to align with gaps between teeth of the first gear.
Clause 6: The toothbrush head of clause 2 or 3, further comprising the electric toothbrush, and wherein: (a) the drive shaft comprises a gear that is positioned to contact an interior sidewall of the relatively narrower section when the drive shaft is inserted into the toothbrush head; (b) the interior sidewall of the relatively narrower section comprises a ledge that extends toward the drive shaft; and (c) the ledge is positioned to align with the gear.
Clause 7: The toothbrush head of any of clauses 1-5, wherein the interior sidewall that surrounds the cavity fully surrounds the chamber without a break in the interior sidewall.
Clause 8: A toothbrush head for an electric toothbrush includes: (a) a bristle tray that includes a plurality of bristles; (b) a base having an opening for receiving a drive shaft of an electric toothbrush; (c) a stem that connects the bristle tray to the base and that has an opening; and (d) a coupling member. The coupling member includes (a) a relatively narrower section positioned to align with the stem and (b) a relatively wider section positioned to align with the base. The relatively narrower section has a length that is shorter than that of the drive shaft so that, when the drive shaft is inserted into the coupling member, the drive shaft will extend from the relatively narrower section and into an interior cavity within the stem.
Clause 9: The toothbrush head of clause 8, wherein the interior sidewall of the stem comprises an irregular surface that is positioned to contact the drive shaft when inserted into the toothbrush head.
Clause 10: The toothbrush head of clause 8 or 9, further comprising the electric toothbrush, and wherein the drive shaft comprises an irregular surface that is positioned to contact an interior sidewall of the stem when the drive shaft is inserted into the toothbrush head.
Clause 11: The toothbrush head of clause 8 or 9, further comprising the electric toothbrush, and wherein: (a) the drive shaft comprises a first gear that is positioned to contact an interior sidewall of the stem when the drive shaft is inserted into the toothbrush head; (b) the interior sidewall of the stem comprises a second gear comprising teeth that extend toward the drive shaft; and (c) the teeth of the second gear are positioned to align with gaps between teeth of the first gear.
Clause 12: The toothbrush head of any of clauses 8-11, wherein: (a) the relatively wider section includes a cylindrical first subsection and a funnel-shaped second subsection having a taper that narrows as it gets closer to the relatively narrower section; (b) an exterior sidewall of the relatively wider section includes a corner positioned at a point at which the first subsection transitions to the second subsection; and (c) the base includes a corresponding corner that is positioned to limit a path of travel of the coupling member into the interior cavity of the stem.
Clause 13: The toothbrush head of any of clauses 8-12, wherein the coupling member is integrally formed with the base.
Clause 14: The toothbrush head of any of clauses 8-13, wherein: (a) an exterior sidewall of the coupling member includes threads; (b) an interior sidewall of the stem or the base includes threads; and (c) the threads of the coupling member are configured to mate with the threads of the stem or the base when the coupling member is threaded into the stem or the base.
Clause 15: The toothbrush head of clause 14, further including a seam on the stem, on the base, or between the stem and the base, wherein the seam is positioned to align with the threads of the stem or the base.
Clause 16: A toothbrush comprises a handle with a drive shaft extending therefrom, and a toothbrush head. The toothbrush head includes a bristle tray comprising plurality of bristles, a base having an opening for receiving the drive shaft, a stem that connects the bristle tray to the base and that has an opening, and a coupling member. The coupling member includes a relatively narrower section positioned to align with the stem and a relatively wider section positioned to align with the base. The relatively narrower section has a length that is shorter than that of the drive shaft so that, when the drive shaft is inserted into the coupling member, the drive shaft will extend from the relatively narrower section and into an interior cavity within the stem. An interior sidewall of the stem comprises an irregular surface that is positioned to contact the drive shaft when inserted into the toothbrush head. The drive shaft also comprises an irregular surface that is positioned to contact the interior sidewall of the stem when the drive shaft is inserted into the toothbrush head.
Clause 17: The toothbrush of clause 16 wherein: (a) the irregular surface of the drive shaft comprises a first gear that is positioned to contact the interior sidewall of the stem when the drive shaft is inserted into the toothbrush head; (b) the irregular surface of the stem comprises a second gear comprising teeth that extend toward the drive shaft; and (c) the teeth of the second gear are positioned to align with gaps between teeth of the first gear.
Clause 18: The toothbrush of clause 16 or 17, wherein: (a) the relatively wider section includes a cylindrical first subsection and a funnel-shaped second subsection having a taper that narrows as it gets closer to the relatively narrower section; (b) an exterior sidewall of the relatively wider section comprises a corner positioned at a point at which the cylindrical first section transitions to the tapered second subsection; and (c) the base includes a corresponding corner that is positioned to limit a path of travel of the coupling member into the interior cavity of the stem.
Clause 19: The toothbrush of any of clauses 16-18, wherein the coupling member is integrally formed with the base.
Clause 20: The toothbrush of any of clauses 16-19, further comprising a seam on the stem, on the base, or between the stem and the base, wherein the seam is positioned to align with threads of the stem or the base.

1. A toothbrush head for an electric toothbrush, the toothbrush head comprising:
a bristle tray comprising a plurality of bristles;
a base having an opening for receiving a drive shaft of an electric toothbrush;
a stem that connects the bristle tray to the base and that has an opening;
a coupling member, wherein the coupling member:
comprises an interior sidewall that surrounds a chamber for receiving the drive shaft,
includes a receptacle positioned to align with the opening of the stem, and
does not include or rely on a spring to contact the drive shaft or the stem; and
a pin positioned within the opening of the stem and the receptacle of the coupling member.

2. The toothbrush head of claim 1, wherein the coupling member comprises:
a relatively narrower section positioned to align with the stem; and
a relatively wider section positioned to align with the base.

3. The toothbrush head of claim 2, wherein an interior sidewall of the relatively narrower section comprises an irregular surface that is positioned to contact the drive shaft when inserted into the toothbrush head.

4. The toothbrush head of claim 2 further comprising the electric toothbrush, and wherein the drive shaft comprises an irregular surface that is positioned to contact an interior sidewall of the relatively narrower section when the drive shaft is inserted into the toothbrush head.

5. The toothbrush head of claim 2 further comprising the electric toothbrush, and wherein:
the drive shaft comprises a first gear that is positioned to contact an interior sidewall of the relatively narrower section when the drive shaft is inserted into the toothbrush head;
the interior sidewall of the relatively narrower section comprises a second gear comprising teeth that extend toward the drive shaft; and
the teeth of the second gear are positioned to align with gaps between teeth of the first gear.

6. The toothbrush head of claim 2 further comprising the electric toothbrush, and wherein:
the drive shaft comprises a gear that is positioned to contact an interior sidewall of the relatively narrower section when the drive shaft is inserted into the toothbrush head;
the interior sidewall of the relatively narrower section comprises a ledge that extends toward the drive shaft; and
the ledge is positioned to align with the gear.

7. The toothbrush head of claim 1, wherein the interior sidewall that surrounds the cavity fully surrounds the chamber without a break in the interior sidewall.

8. A toothbrush head for an electric toothbrush, the toothbrush head comprising:
a bristle tray comprising a plurality of bristles;
a base having an opening for receiving a drive shaft of an electric toothbrush;
a stem that connects the bristle tray to the base and that has an opening;
a coupling member, wherein:
the coupling member includes a relatively narrower section positioned to align with the stem and a relatively wider section positioned to align with the base, and
the relatively narrower section has a length that is shorter than that of the drive shaft so that, when the drive shaft is inserted into the coupling member, the drive shaft will extend from the relatively narrower section and into an interior cavity within the stem.

9. The toothbrush head of claim 8, wherein the interior sidewall of the stem comprises an irregular surface that is positioned to contact the drive shaft when inserted into the toothbrush head.

10. The toothbrush head of claim 8 further comprising the electric toothbrush, and wherein the drive shaft comprises an irregular surface that is positioned to contact an interior sidewall of the stem when the drive shaft is inserted into the toothbrush head.

11. The toothbrush head of claim 8 further comprising the electric toothbrush, and wherein:
the drive shaft comprises a first gear that is positioned to contact an interior sidewall of the stem when the drive shaft is inserted into the toothbrush head;
the interior sidewall of the stem comprises a second gear comprising teeth that extend toward the drive shaft; and
the teeth of the second gear are positioned to align with gaps between teeth of the first gear.

12. The toothbrush head of claim 8, wherein:
the relatively wider section includes a cylindrical first subsection and a funnel-shaped second subsection having a taper that narrows as it gets closer to the relatively narrower section;
an exterior sidewall of the relatively wider section includes a corner positioned at a point at which the first subsection transitions to the second subsection; and
the base includes a corresponding corner that is positioned to limit a path of travel of the coupling member into the interior cavity of the stem.

13. The toothbrush head of claim 8, wherein the coupling member is integrally formed with the base.

14. The toothbrush head of claim 8, wherein:
an exterior sidewall of the coupling member comprises threads;
an interior sidewall of the stem or the base comprises threads; and
the threads of the coupling member are configured to mate with the threads of the stem or the base when the coupling member is threaded into the stem or the base.

15. The toothbrush head of claim 14, further comprising a seam on the stem, on the base, or between the stem and the base, wherein the seam is positioned to align with the threads of the stem or the base.

16. A toothbrush, comprising:
a handle with a drive shaft extending therefrom; and
a toothbrush head comprising:
a bristle tray comprising plurality of bristles,
a base having an opening for receiving the drive shaft,
a stem that connects the bristle tray to the base and that has an opening,
a coupling member, wherein:
the coupling member includes a relatively narrower section positioned to align with the stem and a relatively wider section positioned to align with the base; and
the relatively narrower section has a length that is shorter than that of the drive shaft so that, when the drive shaft is inserted into the coupling member, the drive shaft will extend from the relatively narrower section and into an interior cavity within the stem,
wherein:
an interior sidewall of the stem comprises an irregular surface that is positioned to contact the drive shaft when inserted into the toothbrush head, and
the drive shaft comprises an irregular surface that is positioned to contact the interior sidewall of the stem when the drive shaft is inserted into the toothbrush head.

17. The toothbrush of claim 16 wherein:
the irregular surface of the drive shaft comprises a first gear that is positioned to contact the interior sidewall of the stem when the drive shaft is inserted into the toothbrush head;
the irregular surface of the stem comprises a second gear comprising teeth that extend toward the drive shaft; and
the teeth of the second gear are positioned to align with gaps between teeth of the first gear.

18. The toothbrush of claim 16, wherein:
the relatively wider section includes a cylindrical first subsection and a funnel-shaped second subsection having a taper that narrows as it gets closer to the relatively narrower section;
an exterior sidewall of the relatively wider section comprises a corner positioned at a point at which the cylindrical first section transitions to the tapered second subsection; and
the base includes a corresponding corner that is positioned to limit a path of travel of the coupling member into the interior cavity of the stem.

19. The toothbrush of claim 16, wherein the coupling member is integrally formed with the base.

20. The toothbrush of claim 16, further comprising a seam on the stem, on the base, or between the stem and the base, wherein the seam is positioned to align with threads of the stem or the base.
